(19) United States
(12) Patent Application Publication
(10) Pub. No.: US 2025/0035432 A1
(43) Pub. Date: Jan. 30, 2025

(54) DEFLECTOMETRY MEASUREMENT METHOD

(71) Applicant: WYSE LIGHT, SAINT ETIENNE (FR)

(72) Inventor: SURREL Yves, SAINT ETIENNE (FR)

(21) Appl. No.: 18/715,720

(22) PCT Filed: Nov. 28, 2022
(86) PCT No.: PCT/FR2022/052187

§ 371 Date: Jun. 2, 2024

(30) Foreign Application Priority Data
Dec. 2, 2021 (FR) 2112836

(51) Int. Cl. G01B 11/25; G01B 5/00; G01N 21/88

(52) U.S. Cl. CPC G01B 11/2518; G01B 5/0004; G01B 11/2504; G01N 21/8806; G01N 2021/8829

(57) ABSTRACT

A method for taking a measurement from a reflective object (2) or a transparent object (2) by means of a deflectometer (1) including
a display (10) displaying dynamic fringes; a camera (20) configured to acquire images of the fringes reflected by the reflective object (2) and/or images of the fringes transmitted through the transparent object (2); and a computer (30) configured to run a program in order to perform the measurement based on the images acquired by the camera (20). The method includes
successively acquiring the images of the fringes reflected and/or transmitted by the object (2) in at least two configurations of an optical system defined by the display (10), the object (2), and the camera (20); based on the acquired images, running the program and calculating possible solutions for the shape of the object (2) and for the position of the object (2) within the optical system defined by the display (10), the object (2), and the camera (20), in each of the configurations; and obtaining a final solution for the shape and position of the object (2) by identifying a single solution common to the previously calculated possible solutions.

### TECHNICAL FIELD

The invention relates to the technical field of optical measuring instruments, and in particular to the field of deflectometers.

### PRIOR ART

It is known from the prior art to use deflectometry as a means for measuring shape defects. In reference to FIG. 1 of the present application, by displaying fringes on a display (10), it is possible to observe the reflection of these fringes, produced by a reflective object (2) to be measured. By observing the deformation of the reflected fringes, the presence of shape defects can be deduced from this on the reflective surface of the measured object (2).

The disadvantage of this method, is that it does not make it possible to measure the shape of the object as such, but only the defects of the shape of the object. Indeed, the slopes of the surface, which induce a deformation of the projected fringes, are only measurable quantitatively if the shape of the surface is already known. The prior art consists of considering that the object is approximately flat to estimate the slopes. Moreover, calculating a shape based on slopes requires an integration calculation step, which depends on an arbitrary constant. The evaluation of the slopes by this approximative method therefore provides infinite solutions for the shape of the objects.

Although the defects detected by this method can be of a very small dimension, often less than one micrometer, the measurement of the shape is not quantitative. The measurement is only qualitative, since only the defects of the shape are obtained.

A known improvement of this method makes it possible to use deflectometry as a semi-quantitative measuring means. In this case, the measuring method uses additional input data, such as distances between the camera, the object and the display, and the mutual orientation angles. The integration constant can thus be determined, which makes it possible for the measurement to provide the shape of the object. The disadvantage is that the measurements of the additional input data must be very small, such that the method provides satisfactory results, as these data must be transformed such that they are expressed in a single system (“alignment”), which requires to determine, very precisely, the position of the auxiliary measuring appliances which are used.

Or thus, the measurement of the shape defects is applied to a known nominal shape of the object to be measured, which makes it possible to obtain the actual shape of the measured object. This method has the disadvantage of necessarily knowing the theoretical shape of the object to be measured to be able to obtain its actual shape, which induces certain approximations in the quality of the measurement.

A last measuring method using deflectometry consists of making a geometric reconstruction of the object, by triangulation. While in other measuring methods, the display and the camera are fixed, this method requires a mobility of the display. In reference to FIG. 2, illustrating the prior art:
starting with an incident ray (ri) known and captured by the camera (10);
then by determining the optical path of an emitted ray (re), defined by a first pixel (P1) displayed by the display (10) when it is in a first position (10₁) and by a second pixel (P2) displayed by the display (10) when it is in a second position (10₂);
   thus the intersection of the incident ray (ri) and of the emitted ray (re) provides a point O of the object (2).

By proceeding with such a geometric reconstruction for each of the incident rays of the camera, it is possible to obtain each point of the surface of the reflective object to be measured, and therefore its shape.

However, the disadvantage of this method by triangulation is that it gives results, the quality of which is mediocre, the precision of the measurement being, at best, ten micrometres, insofar as this method is based on the calculation of a ray intersection point, extremely sensitive to the slightest error on the propagation direction of these rays. This approach does not take advantage at all of one of the main features of deflectometry, namely its intrinsic differential aspect resulting from its dependency on the slopes of the object to be measured.

The methods of the prior art are therefore not adapted for measuring objects, the knowledge of which, of the shape to the closest micrometre is fundamental. For telescope mirrors or lenses, for example, these deflectometry methods are therefore not suitable.

Interferometry is another measuring method, which makes it possible to obtain the shape of an object with an uncertainty which is a lot less than to one micrometre, and is the reference method for measuring quality of shape of optical mirrors. However, an interferometer is an expensive appliance, very sensitive to vibrations and which requires complementary elements for measuring shapes, other than planes or spheres. These elements are themselves also very expensive most of the time. These can be compensation parts which are manufactured bespoke, and commonly called “null”, or also holograms generated by a computer.

Another optical measuring method is stereo deflectometry, wherein a camera must acquire images of the object to be measured according to different angular configurations. This method has the disadvantage of restricting the field which is measurable by the camera.

A last method is measuring using a machine to measure three-dimensionally, which takes spatial measurements using a sensor, in numerous points of the object to be measured. These machines are, on the one hand, expensive, and on the other hand, very slow, as the spatial resolution of the measured shape is directly connected to the number of measured points. Such a machine in addition operates in a regulated environment, in particular by temperature, such that the measurement is correct.

### SUMMARY OF THE INVENTION

The aim of the invention is to overcome the disadvantages of the prior art, by proposing a simple, inexpensive measuring method, making it possible to obtain the shape of an object with a quality close to the interferometry methods of the prior art.

Another aim of the invention is to design a measuring appliance configured for the implementation of such a method, the appliance also needing to be simple to use and inexpensive.

To this end, a method for taking a measurement from a reflective object or a transparent object by means of a deflectometry has been developed, comprising:
a display displaying dynamic fringes;
a camera configured to acquire images of the fringes reflected by the reflective object and/or images of the fringes transmitted through the transparent object;
a computer configured to run a program in order to perform the measurement based on the images acquired by the camera.

According to the invention, the method comprises the following steps:
successively acquiring the images of the fringes reflected and/or transmitted by the object in at least two configurations of an optical system defined by the display, the object and the camera;
based on the acquired images, running of the program and calculating possible solutions for the shape of the object and for the position of the object within the optical system defined by the display, the object and the camera, in each of the configurations;
obtaining a final solution for the shape and for the position of the object by identifying a single solution common to the previously calculated possible solutions.

The measurements performed in each of the configurations provide infinite solutions, due to unknown integration constants. Among all these possible solutions, only one is the actual solution, called “final solution”. Comparing possible solutions in the different configurations removes incoherent solutions, as a single solution is common to the two configurations: the shape of the object is thus obtained, as well as its position within the optical system.

In this way, the method makes it possible to obtain the shape of the object, and not only its shape defects. The method does not use additional input data. It is therefore possible to obtain the measurement of the object based on the single object: the method is simplified and the approximation errors are therefore avoided.

The method using the reflection of the fringes, and by that, the slopes of the shape to be measured, the uncertainty on the measurement is comparable to that of a measurement obtained by interferometry.

In an embodiment, the method comprises a step of calibrating the deflectometer by successively acquiring images of the fringes in at least two configurations, and preferably at least three, of an optical system defined by the display positioned directly facing the camera. This calibration method is simple and makes it possible to guarantee the reliability and the performance of the method. The calibration, only making the display and the camera intervene, makes it possible to correctly identify the path of each incident ray of the camera and the actual shape of the display, in view of subsequent measurements.

For the method to be compatible with the measurement of a reflective object, an additional step is necessary. It consists of moving the display and/or the camera, such that they are no longer aligned, and of having a reference mirror so as to reflect the projections of the display in the direction of the camera.

To verify the correct operation of the deflectometer at the end of its calibration, the measurement of the reference mirror is previously obtained by another means, such as an interferometer, and the calibration step comprises an additional step, consisting of measuring the reference mirror by means of the deflectometer, and comparing the measurement obtained by the deflectometer with the previous measurement.

The invention also relates to a deflectometer to perform a measurement on a reflective object or a transparent object comprising:
a display displaying dynamic fringes;
a camera configured to acquire images of the fringes reflected by the reflective object and/or images of the fringes transmitted through the transparent object;
a computer configured to run a program in order to perform the measurement based on images acquired by the camera.

According to the invention, the display and/or the camera are mounted on a frame with capacity to move between at least two positions, such that the camera captures images according to at least two configurations of an optical system defined by the display, the object and the camera;

and the measurement of the object is a calculation of its shape, the computer program is configured to calculate the geometry of the object only based on images acquired by the camera in the at least two configurations, and the calculation is made by integration of the slopes measured in each configuration.

In this way, the deflectometer integrates inexpensive components.

Finally, such a deflectometer does not require to use additional input data, and is therefore simple to use: it is sufficient to have the object to be measured within the optical system defined by the display, the object and the camera to be able to perform the measurement. There is no step limiting the precise positioning or alignment of the object or of another element.

In order to guarantee the repeatability of the positioning of the display and/or of the camera in each configuration, they are mounted on the frame by an isostatic connection, which means that this connection creates no deformation of the mechanical structures in question, which would be a source of measurement errors. In addition, an isostatic mounting can be less expensive than mechanical precision systems, such as a precision screw.

To facilitate the movement of the display and/or of the camera, this is ensured by a two-stage system comprising a first stage which can be moved with respect to the frame, and transporting a second stage on which the display and/or the camera is fixed; the second stage is retractable between:
a free position, wherein it does not impede the movement of the first stage with respect to the frame, and
an indexed position, wherein it impedes the movement of the first stage, and is in isostatic connection with the frame.

The operator therefore does not need to carry the display and/or the camera to move them from one configuration to another.

In a preferred embodiment, the isostatic connection is of the Boys connection type, as this connection is simple to implement.

In this embodiment, the Boys connection is achieved by three spherical portion pins positioned in a triangle at a lower face of the second stage opposite the frame, each intended to bear between two internal faces of a V positioned opposite an upper face of the frame.

In order to simplify the mechanical construction of the kinematic connections, the display and/or the camera can be moved along a rectilinear axis.

Always with an aim of facilitating the use of the deflectometer, the movement of the display and/or of the camera is ensured by:
a motorised horizontal slide connection ensuring the movement of the first stage with respect to the frame;
a motorised vertical slide connection making it possible to retract the second stage between the free position and the indexed position, and the vertical slide connection has a clearance.

With an aim of automating the measurement, the motors of the horizontal and vertical slide connections are connected to the computer, and the computer program is configured to automatically control the motors to move the display and/or the camera between the positions.

### BRIEF DESCRIPTION OF THE DRAWINGS

FIG. 1 is a diagram illustrating the deflectometry principle.

FIG. 2 is a diagram illustrating a deflectometry method of the prior art.

FIG. 3 is a diagram illustrating the calibration of the method according to the invention.

FIG. 4 is a diagram illustrating the method according to the invention during the measurement of a transparent object.

FIG. 5 is a diagram illustrating another calibration step of the method.

FIG. 6 is a diagram illustrating the multiple solutions obtained during a measurement in a first configuration.

FIG. 7 is another diagram illustrating several solutions obtained following a measurement in the first configuration.

FIG. 8 is a diagram illustrating the multiple solutions obtained during the measurement in a second configuration.

FIG. 9 is a diagram illustrating the comparison of solutions obtained in the first and the second configuration.

FIG. 10 is a diagram of a camera of a deflectometer according to the invention.

FIG. 11 is a diagram of a display of a deflectometer according to the invention.

FIG. 12 is a diagram of a Boys connection.

FIG. 13 is a diagram of another Boys connection.

FIG. 14 is a diagram illustrating a two-stage system transporting the display and/or the camera.

FIG. 15 is another diagram illustrating the two-stage system.

FIG. 16 is a diagram illustrating cradles for positioning the display.

FIG. 17 is a diagram illustrating the measurement of an object by stereo deflectometry.

FIG. 18 is a diagram illustrating the measurement of the same object according to an embodiment of the invention.

### DETAILED DESCRIPTION OF THE INVENTION

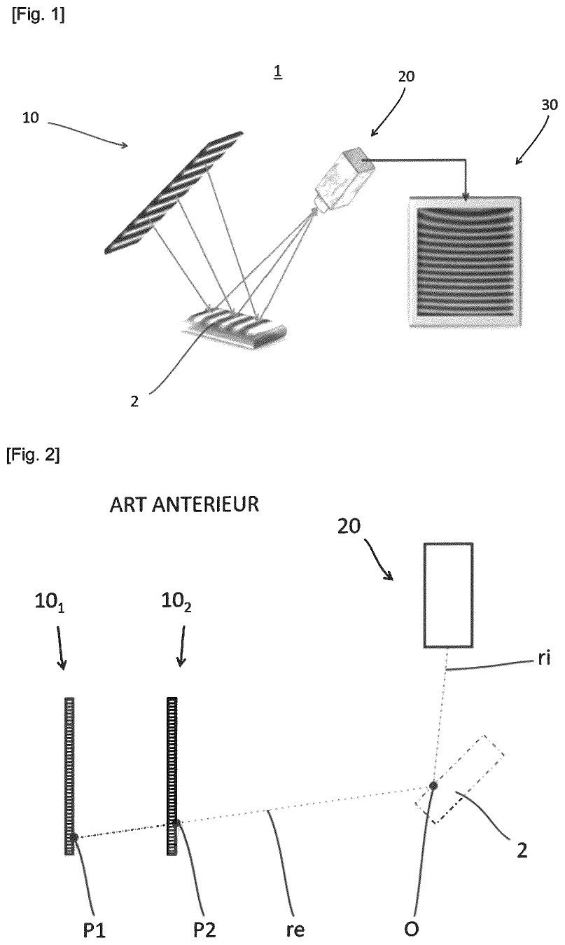

In reference to FIG. 1, the deflectometry is a method for measuring an object (2), implementing a deflectometer (1) comprising a display (10) projecting fringes, and the reflection of which by the object (2) is acquired by a camera (20). The displayed fringes are a predetermined dynamic sinusoidal pattern. This predetermined sinusoidal pattern makes it possible to know, for each pixel captured by the camera (20), from which pixel it provides on the display (10). This corresponds to the prior art widely known as phase shift measurement.

The reflected pattern being deformed by the actual shape of the object (2), a computer (30) interprets the deformations of the reflected fringes, in order to determine, by calculation, the shape of the object (2).

By shape of the object (2), this means its geometry, its dimensions, and the measurement of its shape defects, up to a scale of around one micrometer. The deflectometer (1) according to the invention also makes it possible to obtain the position of the object (2) within the optical system defined by the display (10), the object (2) and the camera (20).

FIG. 1 illustrates a typical case of measuring by deflectometry, where the object (2) is reflective: in this case, the measurement consists of obtaining the shape of the reflective surface of the object (2). But, it can also be considered to proceed with measuring a transparent object (2), in which case the measurement consists of obtaining the overall shape of the object (2), not only the shape of one of its surfaces.

In reference to FIG. 3, a calibration step of the method consists of placing the camera (20) directly facing the display (10). During this step, the display (10) and/or the camera (20) are moved in several configurations, and an acquisition of the displayed fringes is performed each time.

This calibration step makes it possible to perfectly know the shape of the display and the optical paths of the incident rays (ri) to the camera (20), coming from the display (10), in each of the configurations. I.e. based on each pixel of the display, the path of the incident ray (ri) is determined, connecting it to the camera (20). Three rays (ri₁, ri₂, ri₃) have been represented, corresponding to three pixels (P1, P2, P3).

This step also makes it possible to know the movement which has been performed within the system between each configuration: the comparison of the images acquired by the camera (20) between each configuration makes it possible, via the calculations performed by a computer program (30), to determined which refined transformation makes it possible to pass from one configuration to another. These refined transformations will be used during subsequent steps of measuring the object (2). A refined transformation is the composition of a translation and of a rotation, which completely describes the movement of a rigid solid.

The precise knowledge of the path of these incident rays (ri) is necessary for the quality of the subsequent measurements, also the amplitude of the movements between the different configurations must be as large as possible. Indeed, the greater the amplitude is, the more the path of the incident rays (ri) passing through all the positions is determined precisely, however it is important to not design an oversized deflectometer (1). A total amplitude of the movement of around 2 metres is a reasonable compromise between size of the system and quality of the calibration.

This calibration step makes it possible to obtain the equations of all the incident rays (ri) to the camera (20) in the system of the optical system, with a lateral accuracy of around one micrometer, and angular accuracy of around one microradian.

This calibration step also makes it possible to measure the planarity defects of the display, which will make it possible to improve the subsequent measurements of the shape of reflective objects, by using this display (20): it is therefore possible to use a standard display (20), on the market, which is an economic advantage. This relates, for example, to a computer monitor or an ordinary television.

The calibration must be performed periodically, but it is not necessary to redo the calibration before proceeding with measuring each new object (2). Indeed, the stability of the calibration only depends on the geometry of the rigid mechanical structures, which only depends on the temperature, and optionally on the creep of plastic materials being able to mainly intervene in the manufacture of the display and of the camera lens.

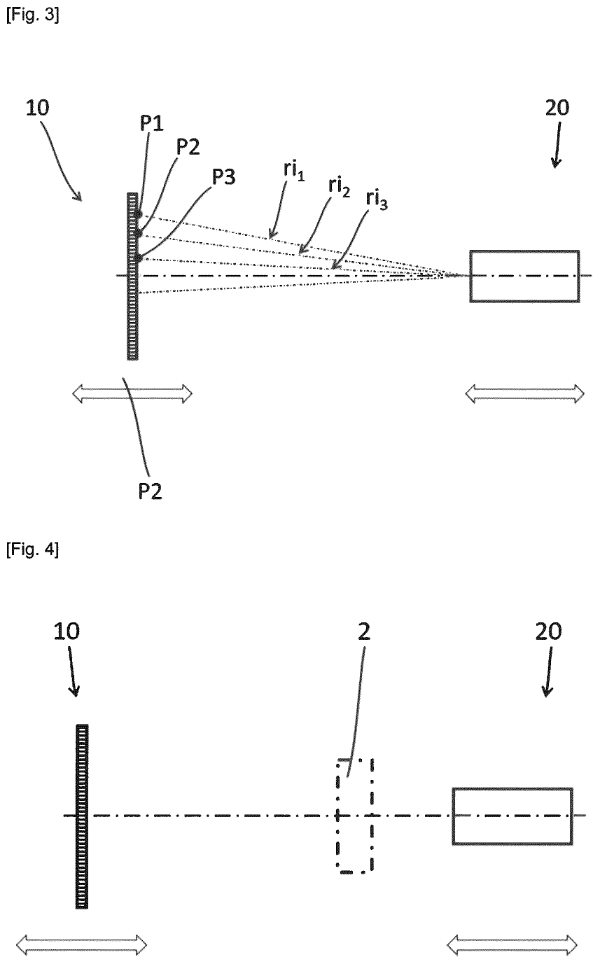

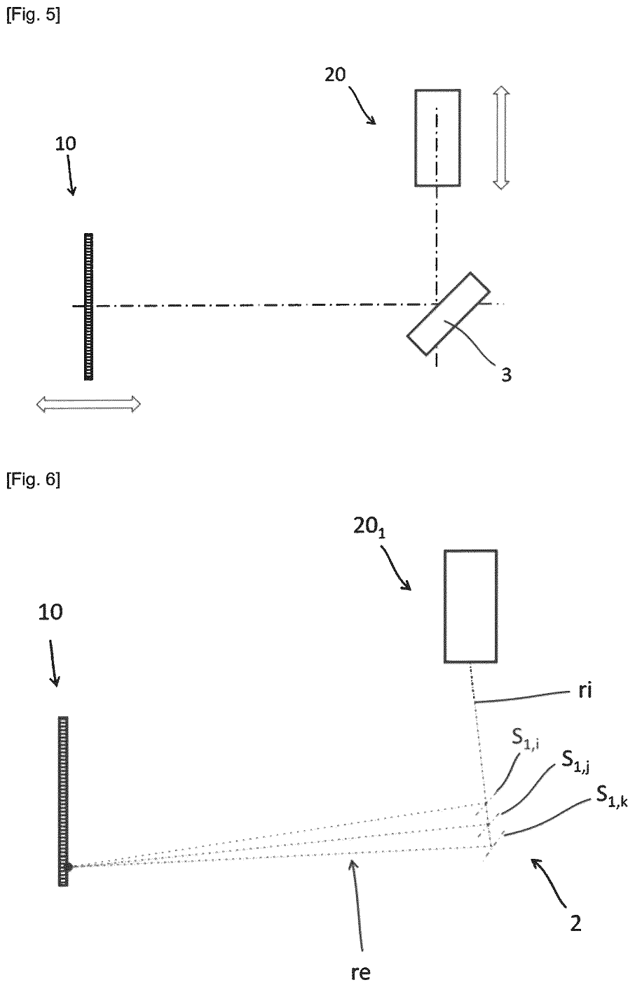

In reference to FIG. 4, once the calibration step is performed, it is possible to proceed with measuring a transparent object (2), by placing it between the display (10) and the camera (20).

However, if the object (2) to be measured is reflective, it is necessary to modify the arrangement of the system, such that the fringes reflected by the object (2) are observable by the camera (20).

In reference to FIG. 5, therefore either the display (10), or the camera (20) is moved, and a reference mirror (3) is placed, such that the camera (20) can have, in its field, the image of the display (10) achieved by the mirror (3).

Since the camera (20) is moved with respect to the display (10), a new refined transformation is applied within the optical system. To be able to precisely identify, without the use of the reference mirror (3) not introducing a new unknown in the optical system, the reference mirror (3) is previously known. I.e. that its exact shape has been measured, for example by interferometry or using another deflectometer already calibrated.

The refined transformation corresponding to the movement of the camera (20) with respect to the display (10) can be determined based on acquisitions of images of fringes of the display (10) when the reference mirror (3) is in at least three different arbitrary positions, enabling the camera (20) to have these fringes in its field. There is no limitation on the quality or the repeatability of the positioning of the reference mirror (20) in this step. It is a loose positioning.

In reference to FIG. 6, the reference mirror (3) is then removed, and the object (2) is positioned such that the camera (20) has fringes seen by reflection in its field. The camera (20) first acquires the reflected fringes, in a first configuration where the camera (20) is in a first position (20₁).

Since the display of the fringes is a predetermined pattern, and since the incident rays (ri) to the camera (20) have all been identified during the calibration step, its starting point is known, for each incident ray (ri), from the display (10). The unknown is the shape and the position of the object (2) having enabled its reflection in the direction of the camera (20).

The computer program (30) is programmed to perform the calculations making it possible to identify the possible solutions for the shape and for the position of the object (2). As explained, for each configuration of the optical system defined by the display (10), the object (2) and the camera (20), infinite solutions are possible. FIG. 6 represents three solutions of the first configuration (S_{1,i}, S_{1,j}, S_{1,k}), each being able to correspond to a different emitted ray (re) and to a slope and a different position of the surface of the object (2).

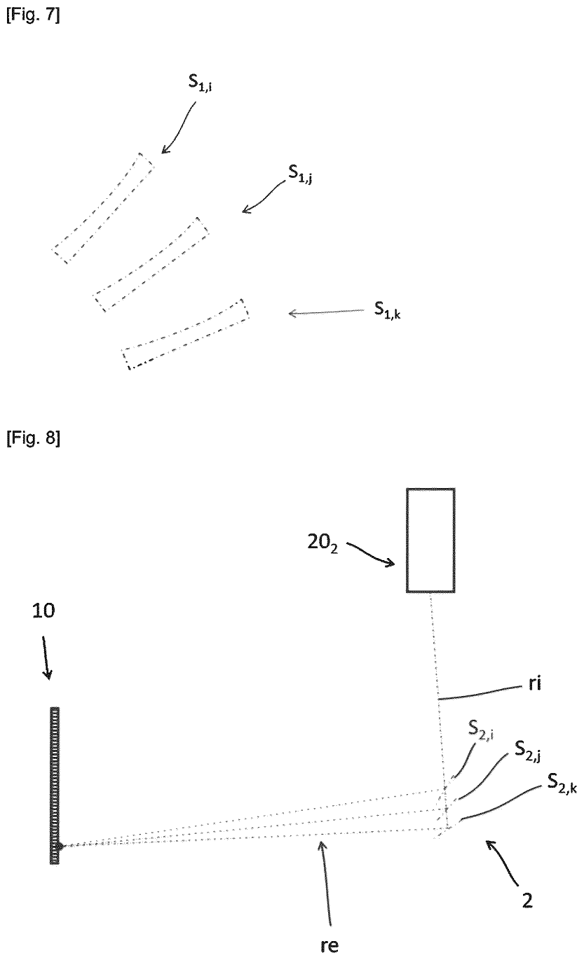

The same determination is performed for each incident ray (ri) to the camera (20), which makes it possible to obtain the complete shape of the object (2), such as represented in FIG. 7.

FIG. 7 schematises multiple shape and position solutions in the space which are obtained by the measurement in the first configuration.

In reference to FIG. 8, the camera (20) has been moved and is located in a second position (20₂). A new acquisition is made in this second configuration of the optical system.

Similarly, the knowledge of the incident rays (ri) and of their starting points from the display (10) makes it possible to obtain multiple solutions of the second configuration. In order to facilitate reading FIG. 8, only the portions of the three solutions of the second configuration (S_{2,i}, S_{2,j}, S_{2,k}) are represented.

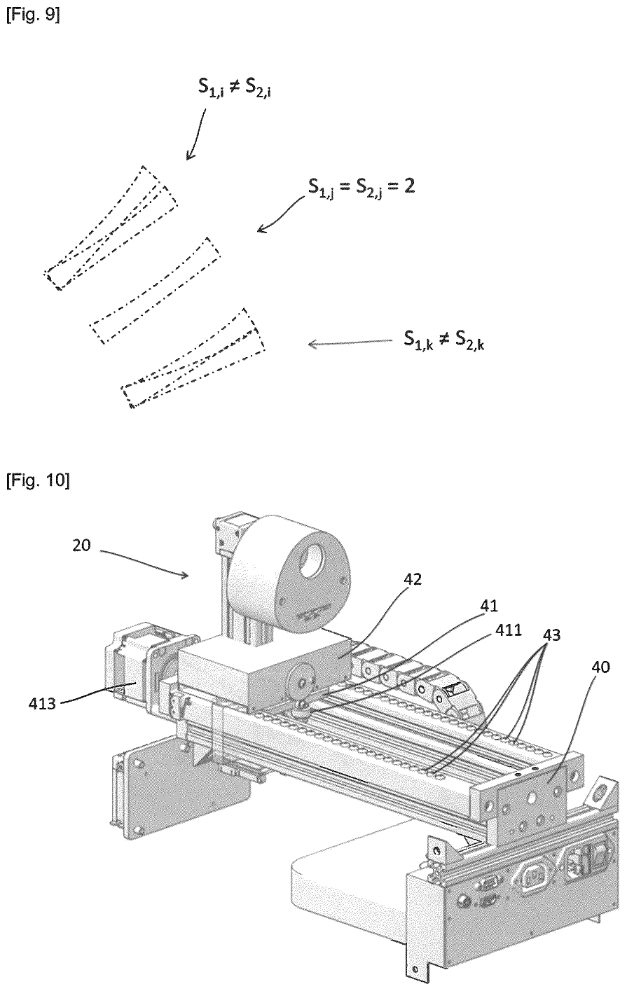

In reference to FIG. 9, the last step of the method according to the invention is to compare the sets of solutions obtained in each configuration, in order to determine which is the only solution which is common to each configuration: this solution corresponds to the actual shape and to the position of the object (2) to be measured.

In order to improve the precision of the measurement, it is advantageous to take measurements in more than two configurations. The measuring uncertainties are thus greatly decreased by the so-called “least squares” minimisation procedures which are used.

The invention also relates to a deflectometer (1) designed to implement the method described above.

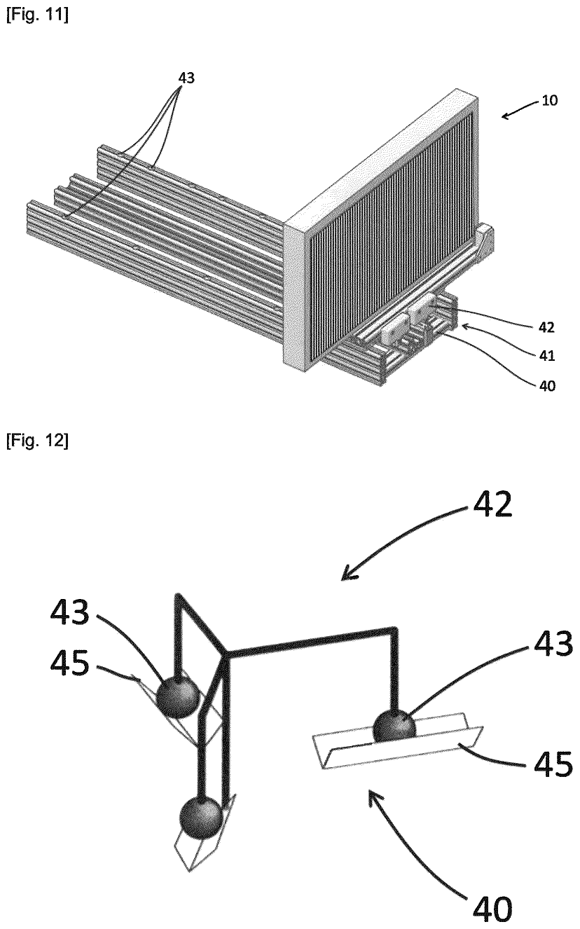

In reference to FIGS. 10 and 11, such a deflectometer (1) comprises a display (10) and a camera (20). At least one of these elements, and preferably both, is movably mounted with respect to a frame (40). It is necessary that at least one of these elements is movable such that the optical system can be mounted in two different configurations.

Whether the display (10), as well as the camera (20) are movable, makes it possible to multiply the number of different configurations, and to be adapted more easily to different object shapes (2) to be measured. It is thus possible to measure concave mirrors and convex mirrors with one same deflectometer (1).

The frame (40) is preferably made of two parts, in order to be able to pass easily from a position where the display (10) and the camera (20) are aligned for the calibration step, to a remote position where the display (10) and the camera (20) are remote for the step of measuring a reflective object (2).

With an aim to be simple, the mobility of the display (10) and/or of the camera (20) is an axial translation along an optical axis of the camera (20). The measurement taken is therefore a coaxial deflectometry. In the illustrated embodiment, this mobility is obtained by means of a two-stage system: a first stage (41) is mounted in slide connection with respect to the frame (40). This slide connection can be of any suitable type, an economic means is using profiles engaging with complementarily-shaped rollers (411).

Advantageously, this mobility is motorised, for example by means of a motor (413) driving a pulley and belt system or a worm screw.

The first stage (41) embeds a second stage (42), which is retractable between:
a free position wherein it does not impede the movement of the first stage (41) with respect to the frame (40); and
an indexed position, wherein it impedes the movement of the first stage (41), and the second stage (42) is thus in isostatic connection with the frame (40);
and it is the second stage (42) which carries the display (10) or the camera (20).

The connection between the first stage (41) and the second stage (42) is not a slide connection in the strict sense, as the positioning of the second stage (42) must be free with respect to the first stage (41). This therefore relates to an incomplete kinematic connection, with a lot of clearance.

Indeed, in the indexed position, the second stage (42) is in isostatic connection with the frame (40), such that the indexed position is always repeatable, identical to the closest micrometer, each time that the second stage (42) passes from the free position to the indexed position. If the first stage (41) prevents the second stage (42) from being positioned without limitation on the frame (40), then the configuration of the optical system is not exactly repeatable and the measurement will be compromised.

Performing a movement of the display and/or of the camera in an axial translation (coaxial deflectometry principle) makes it possible to measure objects of larger dimensions, as if the measurement of the object is being taken according to different angles (stereo deflectometry principle).

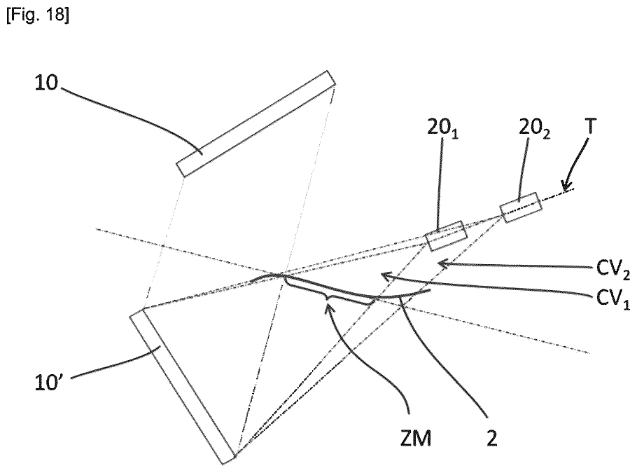

In reference to FIGS. 17 and 18, the measurement of one same reflective object (2) has been illustrated, according to a stereo deflectometry method in FIG. 17, and according to an embodiment of the invention in FIG. 18.

In these figures, a camera (20) is moved according to two positions. The measurable zone (ZM) is at the intersection of the fields of vision (CV₁, CV₂) of each camera (20₁, 20₂). In order to simplify the geometric construction of the figures, a mirror display (10′) has been represented, which is the image of the display (10) such as seen by the camera (20). This relates to a planar symmetry of the display (10) with respect to a plane which is locally tangent to the object (2).

With the stereo deflectometry method illustrated in FIG. 17, to obtain a measurement which can be used, the zone must be measured according to several angular configurations. The measurable zone (ZM) has a restricted surface area. In addition, the stereoscopic effect, therefore the sensitivity of the measurement, increases with the angular difference of the observations, but concomitantly restricts the measurable zone (ZM). It is a serious disadvantage of stereo deflectometry, which is removed by the embodiment illustrated in FIG. 18.

In reference to FIG. 18, the camera (20) is now moved in an axis translation (T), without changing the viewing point of the camera (20). It is observed that the measurable zone (ZM), at the intersection of the fields of vision (CV₁, CV₂) of each camera (20₁, 20₂), is a lot larger. The method according to which the movement path of the display and/or of the camera is an axial translation, therefore makes it possible to measure objects of larger dimensions.

In order to achieve an isostatic connection between the frame (40) and the second stage (42), several solutions can be considered.

In reference to FIG. 12, the second stage (42) can comprise three spherically-shaped elements (43), such as pins or curved head screws, bearing by simple gravity against internal faces of Vs (45), i.e. “V”-shaped wedges, which are disposed on the frame (40). So that the Boys connection works, it is necessary that the Vs (45) are not parallel to one another, and preferably the axes of the Vs (45) converge into one central point of the connection. Equally, the spherically-shaped elements (43) can be positioned on the first stage (41) and the Vs (45) on the second stage (42).

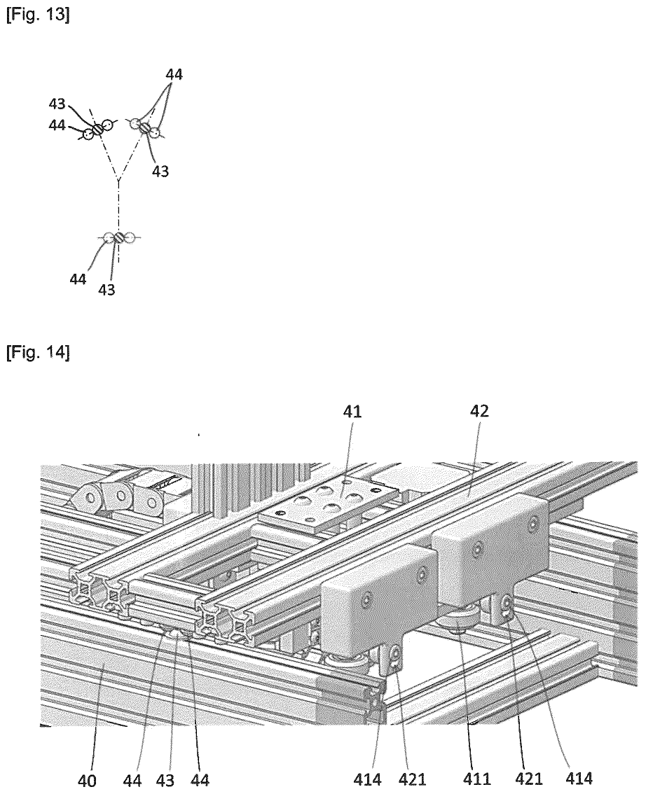

In reference to FIGS. 13 to 15, another solution is to replace each V (45) with a pair of spherical portion abutments (44).

The two mountings are equivalent from a kinematic standpoint, but using Vs (45) enables a great latitude of difference of positions during the docking of the second stage (42) on the frame (40), which simplifies the design of the slide connection with a clearance connecting the second stage (42) to the first stage (41).

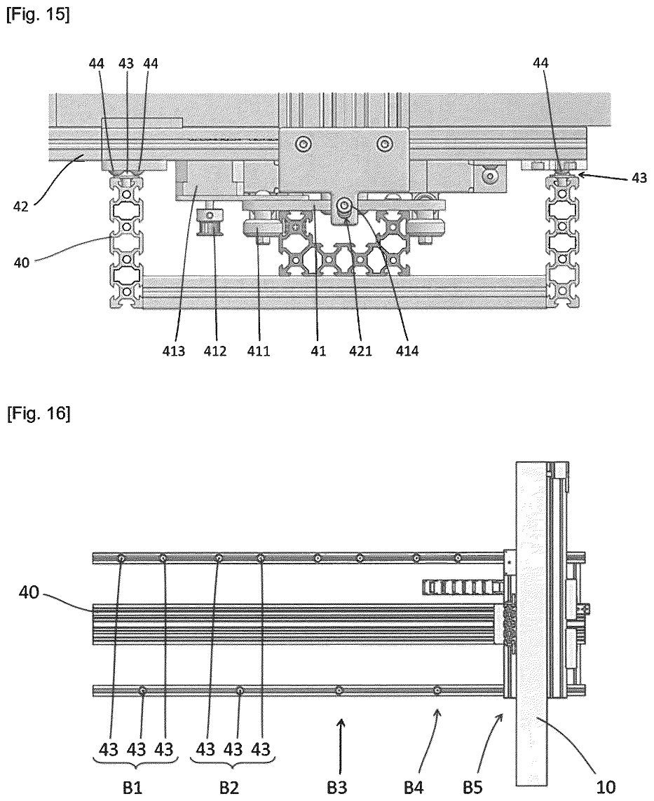

In reference to FIGS. 14 and 15, the free connection between the first stage (41) and the second stage (42) is seen in more detail. The free connection of the preferred embodiment takes the form of axes (414) fixed on the first stage (41), and inserted in oblong orifices (421) of the second stage (42). There is a significant clearance between the axes (414) and the orifices (421), of between 1 mm and 5 mm.

The oblong orifices (421) are vertically oriented, and their length is sufficient to be able to release the Vs (45) or the spherical abutments (44) from the pins (43), thus disconnecting the isostatic connection of the preferred embodiment, since it is normally maintained by gravity.

The passage from the indexed position to the free position is preferably motorised, and can be obtained by means of an actuator or an eccentric mounted on the first stage (41), making it possible to raise the second stage (42).

Naturally, the kinematics and the motorisation of the retraction between the free position and the indexed position can be adapted, if the isostatic connection is of a different construction, for example of the “point, line, plane” type.

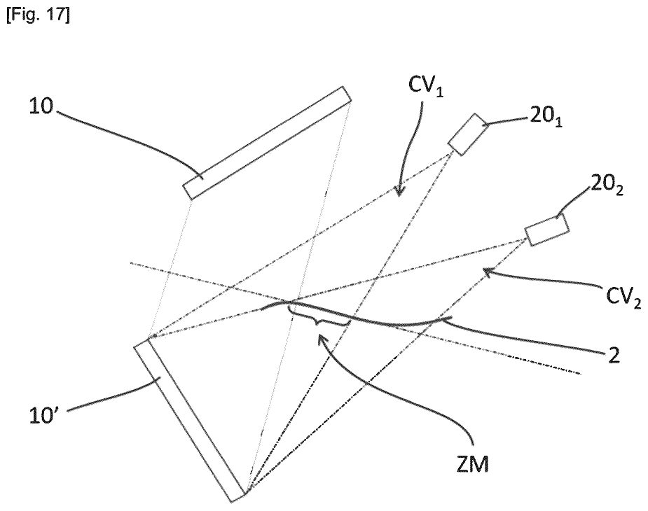

In reference to FIG. 16, the frame (40) comprises several cradles (B1-B5) each configured to isostatically receive the second stage (42). In the illustrated embodiment, each cradle (B1-B5) therefore comprises three pins (43).

In this embodiment, the display (10) is movable between several cradles (B1-B5) distributed over a length of around 2m. The significant length makes it possible to obtain the path of the incident rays (ri) with a significant precision.

The camera (20) itself is movable between several cradles distributed over a length of around 25 cm. This length is sufficient such that the configurations used during the measuring step are sufficiently different, and that the method determines the shape of the object (2) with the expected precision. What is more, this length is sufficiently low, so that the part of the frame (40) which carries the camera (20) is small, which makes it possible to facilitate the passage from the aligned position used for the calibration, to the remote position used for the measurement of a reflective object (2).

In the preferred embodiment, the display (10) and the camera (20) can therefore pass from one configuration to another of the optical system:
in a repeatable manner, to the closest micrometer, as the indexing is performed by an isostatic connection not deforming the parts by the introduction of undue forces;
in an assisted manner, as the mobility and the retraction are motorised;
the system being a lot less expensive than the solutions of the prior art, as it does not use mechanical precision systems, such as micrometric tables or precision ball screws.

Preferably, the computer program (30) is programmed such that each step of the method is automated, and the program comprises instructions to:
perform the measurements in a configuration;
retract the display (10) and/or the camera (20) in the free position;
move the display (10) and/or the camera (20) in order to bring it to the following indexed position;
place the display (10) and/or the camera (20) in the following cradle;
perform the measurements in the new configuration;
and so on, until all the desired measurements are performed;
then determine the measurement of the object (2) by comparing with possible solutions of each of the configurations.

Naturally, the optional adjustments of the camera (20), such as a diaphragm or the opening of a lens are motorised and connected to the computer (30) and are also managed by the program. The automation of the deflectometer (1) is also improved from this.

The same applies for the movement of the reference mirror (3) in at least three different arbitrary positions, during the calibration step.

The deflectometer (1) and the method according to the invention make it possible to take measurements of shapes and of dimensions on objects (2), by only using for that, a display (10) and a camera (20), without any other additional input data. The deflectometer (1) can be usable in environments not specifically provided for metrology and, due to its insensitivity to vibrations, does not require to be positioned on an optical table. The measurements taken are of a metrological quality comparable to interferometers and adapted to the controls of parts for optical imaging, while the means implemented are inexpensive.

The method and the deflectometer (1) can be shaped differently from the examples and from the illustrations given, without moving away from the scope of the invention, which is defined by the claims.

In particular, the mobility of the display (10) and/or of the camera (20) is not necessarily a translation, and the marking of different configurations can be shaped differently from the indexing presented.

In an embodiment not represented, only the display (10) or only the camera (20) is movable between several configurations, in order to save equipment.

In particular, the camera (20) is lighter and smaller to move than the display. In an embodiment, it is therefore only the camera (20) which is movable.

Furthermore, the technical features of the different embodiments and variants mentioned above can be, totally or for some of them, combined with one another. Thus, the method and the deflectometer (1) can be adapted in terms of cost, functionalities and performance.

1. A method for taking a measurement from a reflective object or a transparent object by means of a deflectometer having:
a display displaying dynamic fringes;
a camera configured to acquire the images from fringes reflected by the reflective object and/or the images from fringes transmitted through the transparent object;
a computer configured to run a program in order to perform the measurement based on the images acquired by the camera;
the method comprising the following steps:
successively acquiring the images from fringes reflected and/or transmitted by the object in at least two configurations of an optical system defined by the display, the object and the camera;
based on the images acquired, running the program and calculating possible solutions for a shape of the object and for a position of the object within the optical system defined by the display, the object and the camera, in each of the configurations;
obtaining a final solution for the shape and for the position of the object by identifying a single solution common to the previously calculated possible solutions,
wherein the camera is displaced axially along an optical axis of the camera between successive acquisitions.

2. The measuring method according to claim 1, wherein said method further comprises a step of calibrating the deflectometer by successively acquiring the images from fringes in at least two configurations of an optical system defined by the display positioned directly facing the camera.

3. The measuring method according to claim 2, wherein the calibration step comprises an additional step consisting of moving the display and/or the camera, such that they are no longer aligned, and of placing a reference mirror so as to reflect the projections from the display in the direction of the camera.

4. The measuring method according to claim 3, wherein the measurement of the reference mirror is previously obtained by another means such as an interferometer, and the calibration step comprises an additional step consisting of measuring the reference mirror by means of the deflectometer, in order to verify its correct operation, by comparing the measurement obtained by the deflectometer with the previous measurement.

5. A deflectometer to take a measurement from a reflective object or a transparent object comprising:
a display displaying dynamic fringes;
a camera configured to acquire the images of fringes reflected by the reflective object and/or the images of fringes transmitted through the transparent object;
a computer configured to run a program, in order to take the measurement based on the images acquired by the camera;
wherein the camera is mounted on a frame with the capacity of axial translation along an optical axis of the camera between at least two positions, such that the camera captures images according to at least two configurations of an optical system defined by the display, the object and the camera;
and in that the measurement of the object is a calculation of its shape, the computer program is configured to calculate the geometry of the object only based on the images acquired by the camera in the at least two configurations, and the calculation is made by integration of the slopes measured in each configuration, and
wherein the display and/or the camera are mounted on the frame by an isostatic connection.

6. (canceled)

7. The deflectometer according to claim 5, wherein the movement of the display and/or of the camera is ensured by a two-stage system comprising a first stage which can be moved with respect to the frame, and transporting a second stage on which the display and/or the camera is fixed; the second stage is retractable between:
a free position wherein it does not impede the movement of the first stage with respect to the frame, and
an indexed position wherein it impedes the movement of the first stage, and is in isostatic connection with the frame.

8. The deflectometer according to claim 5, wherein the isostatic connection is of the Boys connection type.

9. The deflectometer according to claim 8, wherein the Boys connection is achieved by three spherical portion pins positioned in a triangle at a lower face of the second stage opposite the frame, each intended to bear against two internal faces of a V positioned opposite an upper face of the frame.

10. The deflectometer according to claim 5, wherein the display (10) and/or the camera (20) can be moved along a rectilinear axis.

11. The deflectometer according to claim 7, wherein the movement of the display and/or of the camera is ensured by:
a motorised horizontal slide connection ensuring the movement of the first stage with respect to the frame;
a motorised vertical slide connection making it possible to retract the second stage between the free position and the indexed position, and the vertical slide connection has a clearance.

12. The deflectometer according to claim 11, wherein the motors of the horizontal and vertical slide connections are connected to the computer, and the computer program is configured to automatically control the motors to move the display and/or the camera between the positions.
